(19) United States
(12) Patent Application Publication
(10) Pub. No.: US 2026/0357869 A1
(43) Pub. Date: Nov. 12, 2026

(54) DRIVE BELT

(71) Applicant: ContiTech Deutschland GmbH, Hannover (DE)

(72) Inventors: Martin Franke, Garbsen (DE); Nico Birkner, Hannover (DE); Joanna Kubiak, Hannover (DE); Tim Fiss, Hannover (DE); Susann Borchers, Nienburg (DE)

(73) Assignees: ContiTech Deutschland GmbH, Hannover (DE); ContiTech Deutschland GmbH, Hannover (DE)

(21) Appl. No.: 19/102,035

(22) PCT Filed: Jul. 10, 2023
(86) PCT No.: PCT/DE2023/200140

§ 371 Date: Feb. 7, 2025

(30) Foreign Application Priority Data
Aug. 8, 2022 (DE) 10 2022 208 244.3

(51) Int. Cl. F16G 1/12; F16G 1/28; F16H 19/06

(52) U.S. Cl. CPC F16G 1/12; F16G 1/28; F16H 19/06

(57) ABSTRACT

The invention relates to a drive belt, having a first conducting element, which is embedded in a polymer material, for transmitting electrical energy, wherein the first conducting element is formed by at least one tensile member that extends in the longitudinal direction of the drive belt, preferably a plurality of tensile members that extend in the longitudinal direction of the drive belt and are arranged parallel to one another. The drive belt has at least one contacting element, to which the first conducting element is electrically connected at the end.

### CROSS-REFERENCE TO RELATED APPLICATIONS

The present application is a National Stage Application under 35 U.S.C. § 371 of International Patent Application No. PCT/DE2023/200140 filed on Jul. 10, 2023, and claims priority from German Patent Application No 10 2022 208 244.3 Filed on Aug. 8, 2022, in the German Patent and Trademark Office, the disclosures of which are herein incorporated by reference in their entireties.

### TECHNICAL FIELD

The invention relates to a drive belt according to the preamble of claim 1.

### BACKGROUND

In many applications and fields, drive belts are used for driving and for transmitting forces in working machines, means of transport, vehicles, etc., specifically both as circulating drive belts in a traction belt drive and as drive belts of finite length in a linear drive or in an elevator system.

In particular in the case of linear drives, parts of the respective device are moved with the aid of the drive belts used therein, for example in the case of a carriage that is moved in a plurality of directions of a working machine, for instance a milling machine or a storage and retrieval unit, or else in the case of a driven print head of a 3D printer.

Usually, in the case of such linear drives for transmitting energy and/or for transmitting measurement signals and control signals, what is referred to as a “cable carrier” is additionally carried along, essentially between the moving part of the working machine and the drive or the central control device, which also processes the signals from the stationary operating devices that are likewise connected thereto. The term “cable carrier” refers to an energy chain by means of which longer cables, energy supplies and control lines are guided on supporting, movable, chain-like holders of a moving machine or a movable device. In this case, the cable carrier thus travels along with the moving part of the working machine, may also have to be deflected and requires corresponding installation space.

Alternatively, a wide variety of embodiments of sliding contacts, for example in the form of current-carrying rails, can be used. Sliding contacts are particularly sensitive to contamination, for which reason the maintenance of the sliding contacts for reliable current and/or signal transmission is very complex and expensive.

Such an energy chain is of course subject to the relevant regulations with regard to servicing and maintenance and has to be checked regularly, as does the actual drive via drive belts. Compliance with such regulations therefore requires regular monitoring and maintenance of the energy chain as well and thus involves considerable additional outlay.

EP 3 462 055 B1 discloses an elevator system having a carrier belt in the form of a drive belt having tensile members for signal or data transmission. The signals or data are fed in or read out between signal-conducting elements and further lines or signal-processing devices via contactings at the respective terminal connection points or fastening points of the signal-conducting elements via a cable clamp. The method for contacting the tensile members is disadvantageously very complex, since each individual one of the tensile members has to be manually freed from the surrounding elastomer material before the electrical contacting with the cable clamp. Such complicated contacting of the tensile members results in correspondingly high production costs.

### SUMMARY

The invention is based on the object of providing a drive belt, wherein the contacting of the tensile members takes place rapidly and/or cost-effectively and/or in a manner that can be automated.

This object is achieved by a drive belt having the features of independent claim 1. Further advantageous embodiments are disclosed in the dependent claims.

Further advantages and features can be found in the general description and in the exemplary embodiments.

The present application relates to a drive belt, having a first conducting element, which is embedded in a polymer material, for transmitting electrical energy, wherein the first conducting element is formed by at least one tensile member that extends in the longitudinal direction of the drive belt, preferably a plurality of tensile members that extend in the longitudinal direction of the drive belt and are arranged parallel to one another. The drive belt can be designed, for example, as a toothed belt, flat belt, V-belt, or V-ribbed belt. The drive belt can be a non-closed drive belt having a predetermined length and two ends. Particularly advantageously, cutting the drive belt to size enables it to be provided at any desired length without incurring costs for individual tools for producing a drive belt of a specific length.

In other words, the tensile member, which can be formed from an electrically conductive material, preferably from metal, can, in addition to the actual function of force transmission, additionally conduct current. This enables current to be conducted from an energy source to a load, for example an electric motor of an actuating drive, via the drive belt, without requiring additional cables for carrying current. The drive belt can preferably be designed as a finite section having a predetermined length having a first end and a second end. Preferably, the polymer material of the drive belt is a polyurethane. The drive belt can be designed as a toothed belt, V-belt, or V-ribbed belt.

The drive belt has at least one contacting element, to which the first conducting element is electrically connected at the end. The drive belt can preferably have the contacting element both at the first end and at the second end. It has proven to be particularly advantageous that an electrically conductive contacting of the tensile member with the contacting element can take place without manually stripping the polymer material surrounding the tensile member from the tensile member. It has also proven to be advantageous that an interface, which enables the first conducting element or the tensile member to be electrically conductively connected to further devices for supplying current and/or for consuming current, can be provided via the contacting element.

According to another aspect of the present invention, the contacting element has at least one pair, preferably a plurality of pairs arranged in the transverse direction, of forked prongs that extend in the vertical direction for receiving at least one tensile member that extends in the longitudinal direction of the drive belt, preferably a plurality of tensile members that extend in the longitudinal direction of the drive belt and are arranged parallel to one another. The contacting element is inserted into the polymer material in the vertical direction. The contacting element can preferably have the same number of pairs of forked prongs as tensile members. In other words, the contacting element can be electrically conductively connected to the tensile member of the drive belt without the tensile member having to be freed from the polymer material of the drive belt. The spacing between two forked prongs of a pair in the transverse direction can in this case correspond at most to the diameter of the tensile member. The spacing between two forked prongs of a pair in the transverse direction preferably corresponds to 80 percent of the diameter of the tensile member. Particularly advantageously, when a spacing between two forked prongs is smaller than the diameter of the tensile member, particularly good electrically conductive contact can be established between the tensile member and the contacting element. Any deformation of the tensile member in relation to the spacing of the pair of forked prongs, between which the tensile member can be received, advantageously causes an increase in the contact surface area between the tensile member and the pair of forked prongs of the contacting element. No polymer material is present in the contact region between the tensile member and the pair of forked prongs. The pairs of forked prongs can be arranged with respect to one another in the spacing between the tensile members. This makes it possible to ensure that one tensile member is assigned to each pair of forked prongs and/or that the tensile member is not damaged when the contacting element is inserted into the polymer material of the drive belt and/or the position of the tensile member in the drive belt is changed. However, a pair of forked prongs can also receive or contact-connect a plurality of tensile members. In order to enable the contacting element to be inserted into the polymer material of the drive belt with the lowest possible force, the polymer material and/or the contacting element can be heated. The polymer material may soften due to the influence of heat, as a result of which the resistance of the polymer material to the insertion of the forked prongs of the contacting element may decrease. In addition, the forked prongs of the contacting element can have knife-like cutting edges, which also make it easier to insert the contacting element into the polymer material.

According to another aspect of the present invention, the contacting element has at least one cylindrical sleeve for receiving a tensile member. The cylindrical sleeve is inserted into the polymer material in the longitudinal direction and encloses the tensile member over a partial length in the longitudinal direction, wherein the cylindrical sleeve is pressed onto the tensile member. Particularly preferably, the drive belt has the same number of cylindrical sleeves as tensile members, so that each tensile member has a cylindrical sleeve as a contacting element. In other words, the cylindrical sleeve can be electrically conductively connected to the tensile member of the drive belt without the tensile member having to be freed from the polymer material of the drive belt. In order to enable the cylindrical sleeve to be inserted into the polymer material of the drive belt with the lowest possible force, the polymer material and/or the cylindrical sleeve can be heated. The polymer material may soften due to the influence of heat, as a result of which the resistance of the polymer material to the insertion of the cylindrical sleeve may decrease. Applying a force to the drive belt in the vertical direction causes the cylindrical sleeve to be pressed together with the tensile member. This enables the electrically conductive connection between the cylindrical sleeve and the tensile member to be improved and permanently ensured under dynamic loading of the drive belt. No polymer material is present in the contact region between the tensile member and the cylindrical sleeve.

According to another aspect of the present invention, the contacting element has at least one mandrel, which is inserted into the tensile member in the longitudinal direction. In order to enable the mandrel to be inserted into the tensile member of the drive belt with the lowest possible force, the polymer material of the drive belt and/or the mandrel can be heated. The polymer material may soften due to the influence of heat, as a result of which the resistance of the polymer material to widening of the diameter of the tensile member when the mandrel is inserted into the tensile member may decrease. The mandrel is preferably designed with a tapering outer contour, for example conically, so that the force for inserting the mandrel into the tensile member can additionally be reduced. Particularly preferably, the drive belt has the same number of mandrels as tensile members, so that each tensile member has a mandrel as a contacting element. It has proven to be particularly advantageous that the contact surface area between the tensile member and the mandrel inserted therein for forming an electrically conductive connection is particularly large. Inserting the mandrel into the tensile member enables any contact between the mandrel and the electrically insulating polymer material of the drive belt to be avoided. In other words, the contact resistance between the mandrel and tensile member can particularly advantageously be kept as low as possible, as a result of which electrical losses when carrying current can likewise be low.

According to another aspect of the present invention, the contacting element has at least one clip, which in particular has a U-shaped design and is inserted into the polymer material in the vertical direction and contactingly surrounds the tensile member. In other words, the contacting element can be designed as a U-shaped wire. In this case, the wire can be designed with a U-shaped radius that corresponds to the outer diameter of the tensile member. The wire may be inserted in the shape of a U, with a first wire end and a second wire end, into the polymer material of the drive belt in the vertical direction, so that a tensile member is received between the first wire end and the second wire end. The wire can pass through the drive belt in the vertical direction, so that the first wire end and the second wire end project out from the opposite side of the drive belt. The wire can be heated, for example by applying a voltage, as a result of which the polymer material of the drive belt can be softened or melted, as a result of which the U-shaped part of the wire can be moved with a small amount of force through the polymer material as far as the tensile strand and electrically conductive contact can be formed between the wire and the tensile strand. The point at which the wire penetrates into the polymer material of the drive belt can be closed again by heating the wire and the polymer material surrounding the wire, as described above. The tensile member can be electrically conductively connected, via the first wire end and the second wire end, to further devices for supplying current and/or for consuming current. Particularly preferably, the drive belt has the same number of clips or wires as tensile members, so that a clip or a wire is assigned as a contacting element to each tensile member.

It is expressly pointed out that the above-explained aspects of the invention, each taken alone or in any technically meaningful combination with one another as well, are each combinable with the subject matter of claim 1.

Exemplary embodiments of the invention will be illustrated schematically and explained in more detail below with reference to the figures.

### BRIEF DESCRIPTION OF THE DRAWINGS

FIGS. 1a and 1b show a schematic cross-sectional illustration of a drive belt according to the invention according to a first exemplary embodiment for contacting a first conducting element.

FIGS. 2a, 2b and 2c show a schematic illustration of a drive belt according to the invention according to a second exemplary embodiment for contacting a first conducting element.

FIGS. 3a and 3b show a schematic illustration of a side view of a drive belt according to the invention according to a third exemplary embodiment for contacting a first conducting element.

FIGS. 4a and 4b show a schematic cross-sectional illustration of a drive belt according to the invention according to a fourth exemplary embodiment for contacting a first conducting element.

The description of the above-mentioned figures is given in Cartesian coordinates with a longitudinal direction X, a transverse direction Y, which is perpendicular to the longitudinal direction X, and a vertical direction Z, which is perpendicular both to the longitudinal direction X and to the transverse direction Y. The longitudinal direction X may also be referred to as the depth X, the transverse direction Y may also be referred to as the width Y, and the vertical direction Z may also be referred to as the height Z. The longitudinal direction X and the transverse direction Y together form the horizontal X, Y, which can also be referred to as the horizontal plane X, Y. The longitudinal direction X, the transverse direction Y and the vertical direction Z can also be referred to together as spatial directions X, Y, Z or as Cartesian spatial directions X, Y, Z.

### DETAILED DESCRIPTION

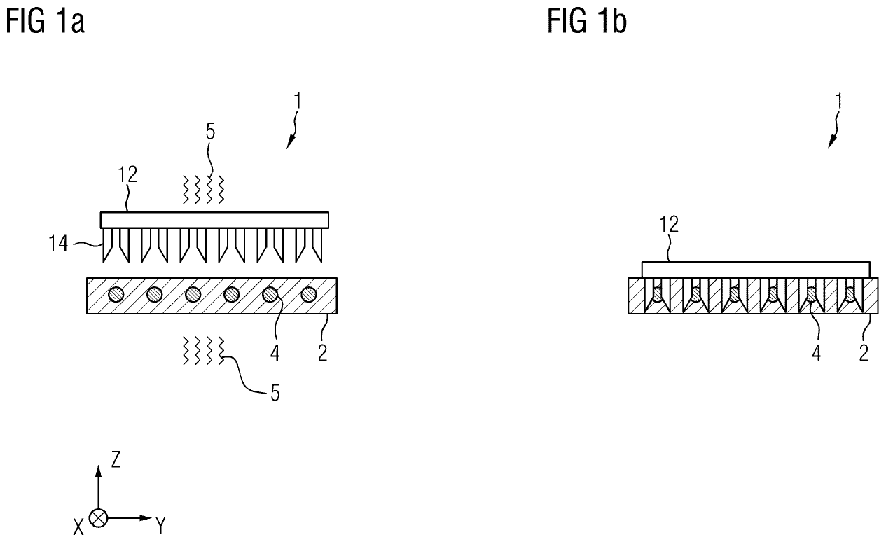

FIG. 1a shows a first embodiment of the drive belt 1 according to the invention having a contacting element 12 having six pairs of forked prongs 14. The contacting element 12 is designed to be electrically conductively connected to the tensile member 4. The forked prongs 14 extend in the vertical direction Z and are arranged in the form of six pairs in a transverse direction Y. In other words, the exemplary embodiment illustrated has six pairs or twelve forked prongs 14. The schematically illustrated drive belt 1 has six tensile members 4, which are embedded in a polymer material 2, preferably polyurethane. The tensile members 4 form a first conducting element 4 for current transmission and comprise a metallic material. The tensile members 4 extend in the longitudinal direction X of the drive belt 1 and are arranged so as to be spaced apart from one another in the transverse direction Y. The spacing between two forked prongs 14 of a pair in the transverse direction Y corresponds to 80 percent of the diameter of the tensile member. The pairs of forked prongs 14 are arranged with respect to one another in the spacing between the tensile members 4. Thus, one tensile member 4 is assigned to each pair of forked prongs 14. Aligning the forked prongs 14 with respect to the tensile members 4 prevents the tensile members 4 from being damaged when the contacting element 12 is inserted into the polymer material 2 of the drive belt 1. The polymer material 2 of the drive belt 1 and the contacting element 12 are heated by a heat source 5. The heating causes the polymer material 2 to soften and to present a lower resistance to insertion of the contacting element 12 into the polymer material 2, as a result of which the contacting element 12 can be inserted into the polymer material 2 in the vertical direction Z with a small amount of force.

FIG. 1b shows the drive belt 1 and the contacting element 12 from FIG. 1a, wherein the contacting element 12 has been inserted into the polymer material 2 of the drive belt 1 and is electrically conductively connected to the tensile member 4. The pairs of forked prongs 14 each receive one tensile member 4 between them. The contacting element 12 can be electrically conductively connected to the tensile members 4 of the drive belt 1 without the tensile members 4 having to be freed from the polymer material 2 of the drive belt 1. By virtue of the fact that the spacing between the pairs of forked prongs 14 is smaller than the diameter of the tensile members 4, the tensile members 4 are deformed between the pairs of forked prongs 14, as a result of which the contact surface area between the tensile member 4 and the pair of forked prongs 14 of the contacting element 12 increases.

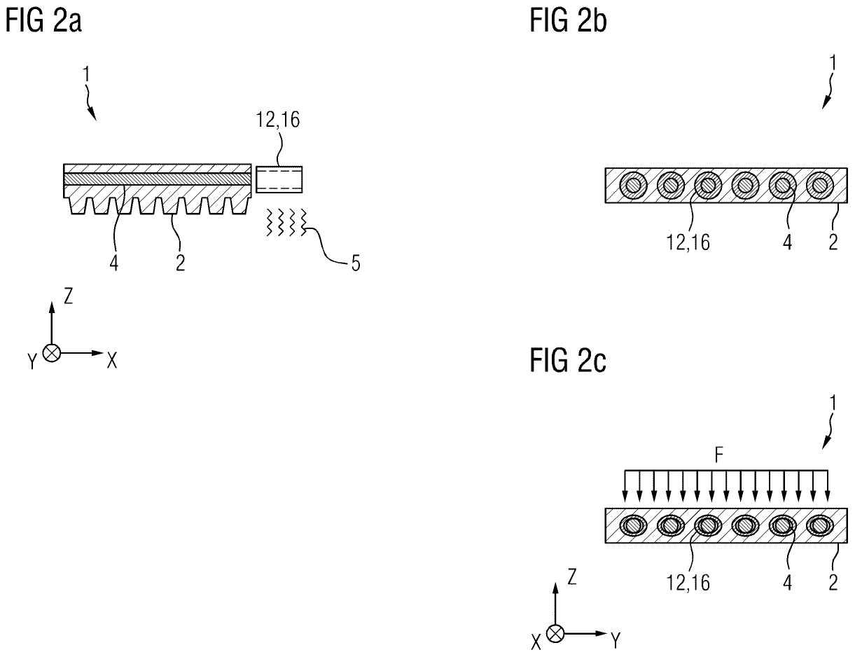

FIG. 2a shows a side view of another embodiment of the drive belt 1 according to the invention in the form of a toothed belt. The contacting element 12 is designed as a cylindrical sleeve 16 for receiving a tensile member 4. The cylindrical sleeve 16 is inserted into the polymer material 2 of the drive belt 1 in the longitudinal direction X and encloses the tensile member 4 over a partial length in the longitudinal direction X. In order to make it easier to insert the cylindrical sleeve 16, the polymer material 2 of the drive belt 1 and the cylindrical sleeve 16 are heated by the heat source 5.

FIG. 2b shows a cross-sectional illustration of the exemplary embodiment from FIG. 2a. It can be seen here that one cylindrical sleeve 16 is assigned in each case as a contacting element 12 to each tensile member 4.

FIG. 2c shows that, as a result of a force F being applied to the drive belt 1 in the vertical direction Z, the cylindrical sleeves 16 are plastically deformed and are electrically conductively connected to the tensile members 4. No polymer material 2 is present in the contact region between the tensile member 4 and the cylindrical sleeve 16.

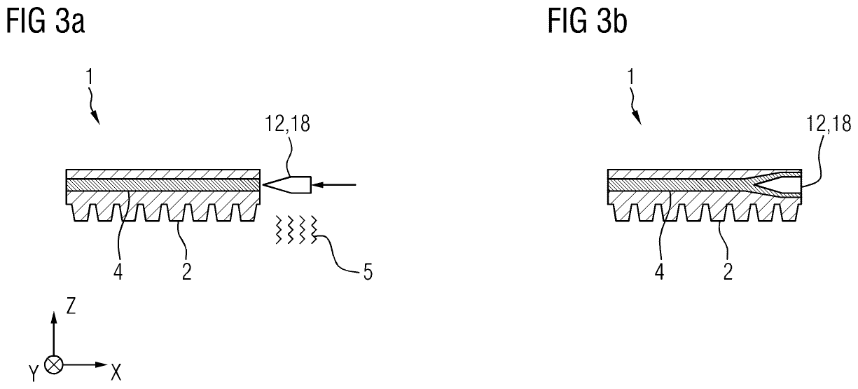

FIG. 3a shows a side view of another embodiment of the drive belt 1 according to the invention in the form of a toothed belt, wherein the contacting element 12 is designed as a mandrel 18. In order to keep the force required for inserting the mandrel 18 into the tensile member 4 of the drive belt 1 in the longitudinal direction X as low as possible, the mandrel 18 is heated by a heat source 5. The polymer material 2 may soften due to the influence of heat, as a result of which the resistance of the polymer material 2 to widening of the diameter of the tensile member 4 when the mandrel 18 is inserted into the tensile member 4 decreases. The diameter of the mandrel 18 widens conically, with the result that the force required for inserting the mandrel 18 into the tensile member 4 is additionally reduced. The drive belt 1 has the same number of mandrels 18 as tensile members 4, so that each tensile member 4 has a mandrel 18 as a contacting element 12.

FIG. 3b shows the drive belt 1 from FIG. 3a, wherein the mandrel 18 has been inserted into the tensile member 4 in the longitudinal direction X. The tensile member 4 has widened in diameter in the region around the mandrel 18. The mandrel 18 is substantially surrounded by the tensile member. As a result of the contact between the mandrel 18 and the tensile member 4, an electrically conductive connection is formed between the mandrel 18 and the tensile member 4.

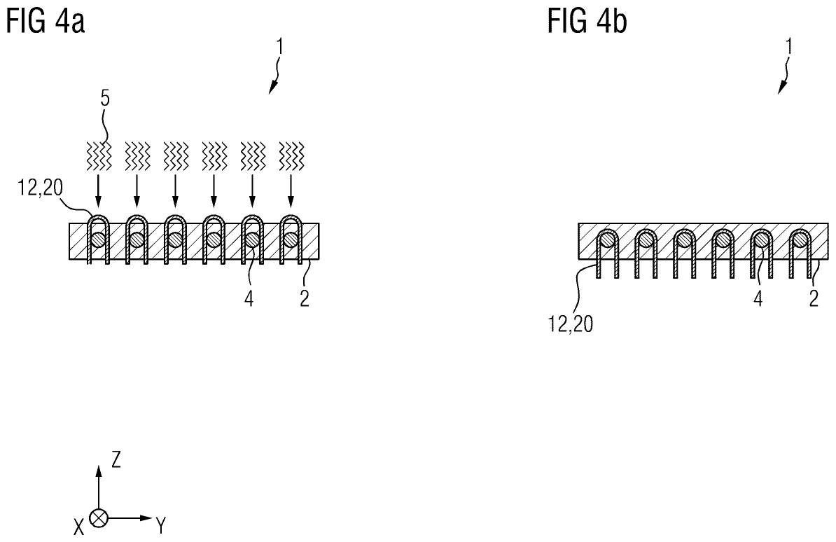

FIG. 4a shows a cross section through another embodiment of the drive belt 1 according to the invention, wherein the contacting element 12 is designed as a U-shaped wire 20. The wire 20 is inserted in the shape of a U, with a first wire end and a second wire end, into the polymer material 2 of the drive belt 1 in the vertical direction Z, so that a tensile member 4 is received between the first wire end and the second wire end. The wire 20 passes through the drive belt 1 in the vertical direction Z, so that the first wire end and the second wire end project out from the opposite side of the drive belt 1. The wire 20 is heated, for example by applying a voltage to the first wire end and to the second wire end, as a result of which the polymer material 2 of the drive belt 1 softens or melts, as a result of which the U-shaped part of the wire 20 is moved with a small amount of force through the polymer material 2 as far as the tensile strand 4. The drive belt 1 has the same number of wires 20 as tensile members 4, so that a wire 20 is assigned as a contacting element 12 to each tensile member 4.

FIG. 4b shows the drive belt 1 from FIG. 4a, wherein the wires 4 are inserted into the polymer material 2 of the drive belt 1 in the vertical direction Z to such an extent that the tensile members 4 are surrounded in a U-shaped manner by the wires 20 and electrically conductive contact is formed between the wire 20 and the tensile strand 4. The U-shaped radius of the wire 20 corresponds to the outer diameter of the tensile member 4.

1. A drive belt comprising:
a first conducting element, which is embedded in a polymer material, for transmitting electrical energy,
wherein the first conducting element is formed by at least one tensile member that extends in a longitudinal direction (X) of the drive belt, a plurality of tensile members extend in the longitudinal direction of the drive belt and are arranged parallel to one another, and
wherein the drive belt has at least one contacting element, to which the first conducting element is electrically connected at the end.

2. The drive belt as claimed in claim 1,
wherein the contacting element has at least one pair of forked prongs extending in a vertical direction (Z) for receiving at least one tensile member that extends in the longitudinal direction of the drive belt,
wherein the contacting element is inserted into the polymer material in the vertical direction.

3. The drive belt as claimed in claim 1,
wherein the contacting element has at least one cylindrical sleeve for receiving a tensile member,
wherein the cylindrical sleeve is inserted into the polymer material in the longitudinal direction and encloses the tensile member over a partial length in the longitudinal direction, and
wherein the cylindrical sleeve is pressed onto the tensile member.

4. The drive belt as claimed in claim 1,
wherein the contacting element has at least one mandrel, which is inserted into the tensile member in the longitudinal direction.

5. The drive belt as claimed in claim 1,
wherein the contacting element has at least one clip, which in particular has a U-shaped design and is inserted into the polymer material in the vertical direction (Z),
and surrounds the tensile member while contacting it.

6. The drive belt of claim 1, wherein the drive belt is a linear drive.

7. The drive belt of claim 1, wherein the drive belt is a liner drive and part of a storage and retrieval unit.

8. A drive belt, comprising:
a first conducting element, is embedded in a polymer material, for transmitting electrical energy;
the first conducting element is formed by a plurality of tensile members that extend in the longitudinal direction of the drive belt and are arranged parallel to one another;
the drive belt has at least one contacting element, to which the first conducting element is electrically connected at the end;
the contacting element has at least one pair of forked prongs extending in a vertical direction (Z) for receiving at least one tensile member that extends in the longitudinal direction of the drive belt;
the contacting element is inserted into the polymer material in the vertical direction;
the contacting element has at least one cylindrical sleeve for receiving a tensile member;
the cylindrical sleeve is inserted into the polymer material in the longitudinal direction and encloses the tensile member over a partial length in the longitudinal direction; and
the cylindrical sleeve is pressed onto the tensile member; and
the contacting element has at least one mandrel, which is inserted into the tensile member in the longitudinal direction.
